(19) United States
(12) Patent Application Publication
(10) Pub. No.: US 2005/0193854 A1
(43) Pub. Date: Sep. 8, 2005

(54) Cable processor of robot

(75) Inventor: Hiroki Sanemasa, Fukuoka (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA YASKAWA DENKI

(21) Appl. No.: 11/070,181

(22) Filed: Mar. 3, 2005

(30) Foreign Application Priority Data
Mar. 3, 2004 (JP) P.2004-059364

(51) Int. Cl. B25J 17/00

(52) U.S. Cl. 74/490.02

(57) ABSTRACT

The present invention provides a cable processor capable of supplying cables to a plurality of hands attached to a forward end portion of an arm without increasing the size of a joint portion of a robot and further without causing a problem of the breaking of wire at the time of operating the robot.

There is provided a cable processor of a robot for accommodating a cable such as an air pipe or electric wire inside an arm of the robot, and the cable processor comprises: a casing portion (20) for accommodating the cable (21), arranged in a joint drive portion of the robot, wherein the casing portion (21) is provided with rollers (23), which are arranged on an inner wall of the casing portion (21), rotating round a drive shaft of the joint portion.

### BACKGROUND OF THE INVENTION

The present invention relates to a cable processor for accommodating an air pipe and electrical wire, which will be referred to as “a cable” hereinafter in this specification, inside an arm of a robot.

Concerning the conventional processing method of processing a cable in the case of accommodating the cable inside an arm of a robot, there is provided a method in which the cable is elastically wound and accommodated in the arm. Concerning this method, for example, refer to Patent Document 1. Further, there is provided a support device in which a cable is extended in a flexible conduit while extended half round in the forward direction and then folded back upward in the U-shaped direction and extended in the flexible conduit half round in the backward direction so that the cable can be accommodated inside the arm. Concerning this support device, refer to Patent Document 2.

[Patent Document 1]

JP-A-8-57792

[Patent Document 2]

Japanese Patent No. 3452811

However, according to the method disclosed in Patent Document 1, the following problems may be encountered. In the case where cables are supplied to a plurality of hands attached to a forward end of an arm, it is necessary to provide one or more cables which are elastically wound round a circle, the diameter of which is larger. Therefore, the diameter of the joint portion of a robot is increased. Further, since the cable is elastically wound round the circle, it becomes necessary to provide a space in the direction of the winding shaft. Accordingly, the robot arm is extended in the rotary shaft direction of the joint portion.

In the support device disclosed in Patent Document 2, since the cable is folded back by a U-shape, the size of the robot joint portion is increased in the direction of the rotary shaft.

### SUMMARY OF THE INVENTION

The present invention has been accomplished to solve the above problems of the prior art. It is an object of the present invention to provide a cable processor capable of supplying cables to a plurality of hands attached to a forward end of an arm without increasing the size of a joint portion of a robot and further without causing a problem of the breaking of wire at the time of operating the robot.

In order to solve the above problems, the present invention has the following constitution.

The invention described in aspect 1 provides a cable processor of a robot for accommodating a cable such as an air pipe or electric wire inside an arm of the robot, the cable processor comprising: a casing portion for accommodating the cable, arranged in a joint drive portion of the robot, and rollers arranged on an inner wall of the casing, rotating round a drive shaft of the joint portion.

The invention described in aspect 2 provides a cable processor of a robot, wherein an upper face and a lower face inside the casing are subjected to the treatment of fluorine contained resin.

The invention described in aspect 3 provides a cable processor of a robot, wherein the contour of the casing is the same as that of the robot arm.

### BRIEF DESCRIPTION OF THE DRAWINGS

FIG. 1 is a sectional side view of the arm of the embodiment of the present invention.

FIG. 2 is an upper view of the arm of the embodiment of the present invention.

FIG. 3 is a perspective view of the arm of the embodiment of the present invention.

FIG. 4 is a perspective view of the casing of the embodiment of the present invention.

FIG. 5 is an upper view of the peripheral portion of rollers provided in the casing.

FIGS. 6A and 6B are upper views showing a motion of the cable accommodated in the casing when the hand is rotated.

FIGS. 7A and 7B are upper views showing a motion of the cable accommodated in the casing when the hand is rotated.

### DETAILED DESCRIPTION OF THE PREFERRED EMBODIMENTS

Referring to the drawings, a specific embodiment of the method of the present invention will be explained below.

### Embodiment 1

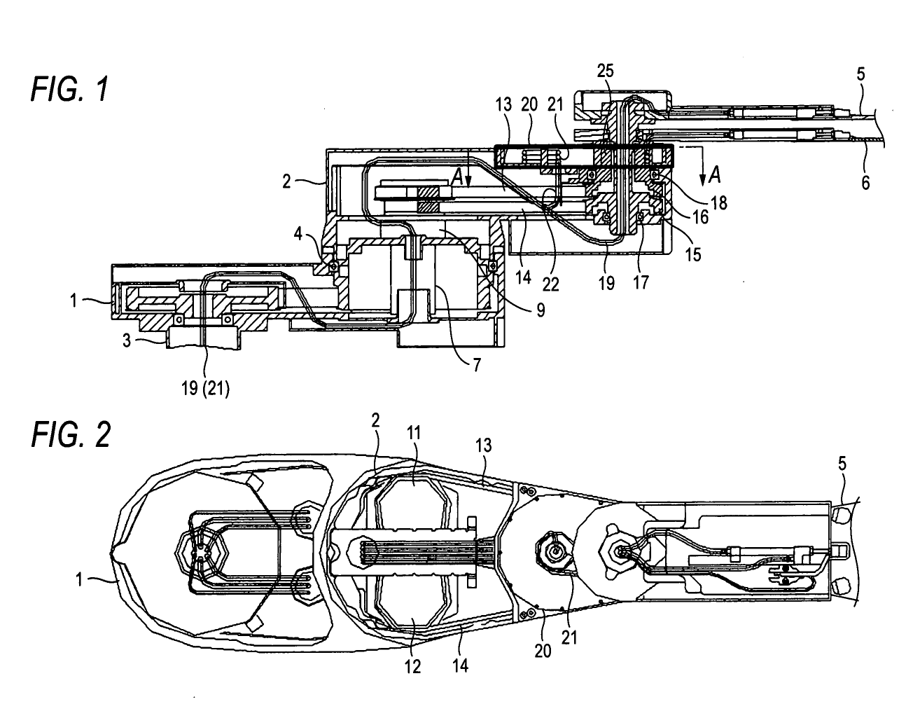

FIG. 1 is a view showing an example of the arm of the horizontal multiple joint robot in which the mechanism of the present invention is used.

FIG. 1 is a sectional central view showing a side the arm, and FIG. 2 is an upper view showing the arm. In this connection, in order to simplify the explanations, the cover and the other members are removed from FIG. 2.

As shown in FIG. 1, the robot includes a first arm 1 and a second arm 2. The first arm 1 on the base portion side is fixed to the shaft 3 which is moved upward and downward and rotated in a predetermined range. The second arm is attached to the first arm 1 via the bearing. 4 so that the second arm can be rotated in a predetermined range.

Two hands for seizing and conveying a workpiece are attached to the forward end of the second arm in such a manner that the two hands are vertically put on each other. In this case, the forward end portions of the two hands are omitted in the drawing. Mechanisms for driving the hands 5, 6 are built in the first 1 and the second arm 2.

When the motor 7 is rotated, the torque generated by the motor 7 is intensified by the speed reducer 9, and the thus intensified torque is transmitted to the pulley 16 by the motor side pulley 11 and the belt 13, and the pulley 16 rotates the hand 6 via the bearing 18.

In the same manner as that described above, when the motor 8 is rotated, the torque generated by the motor 8 is intensified by the speed reducer 10, and the thus intensified torque is transmitted to the pulley 15 by the motor side pulley 12 and the belt 14, and the pulley 15 rotates the hand 5 via the bearing 17.

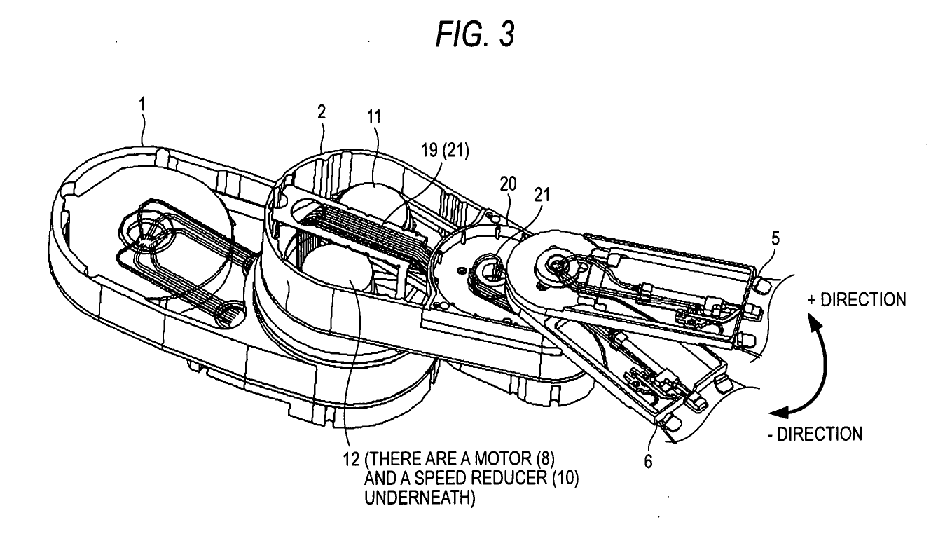

As shown in FIG. 3, by the mechanism described above, the hands 5, 6, which are arranged on the same rotating shaft, are operated independently from each other. In this connection, the motor 8 and the speed reducer 10 are located below the motor side pulley 12 in FIGS. 2 and 3. However, since the motor 8 and the speed reducer 10 are located on the viewer's side of the sectional central view of FIG. 1, they are not drawn in FIG. 1.

An air pipe and electrical wire, which will be referred to as a cable hereinafter, are supplied to the hand 5 via a hollow portion of the pulley 15. On the other hand, the cable 21 is supplied to the hand 6 via the casing 20. The cable 21 is fixed to the support 22 in the second arm 2. Then, the cable 21 passes through in the casing 20 and fixed to the fixing part 25 which is subordinately operated together with the hand 6.

The cables 19, 21 are used as electric power source wires or signal wires connected to the sensors mounted on the hands 5, 6. Further, the cables 19, 21 are also used as pipes for supplying air to drive the cylinders, which are mounted on the hands 5, 6, or supplying vacuum air used for sucking a workpiece.

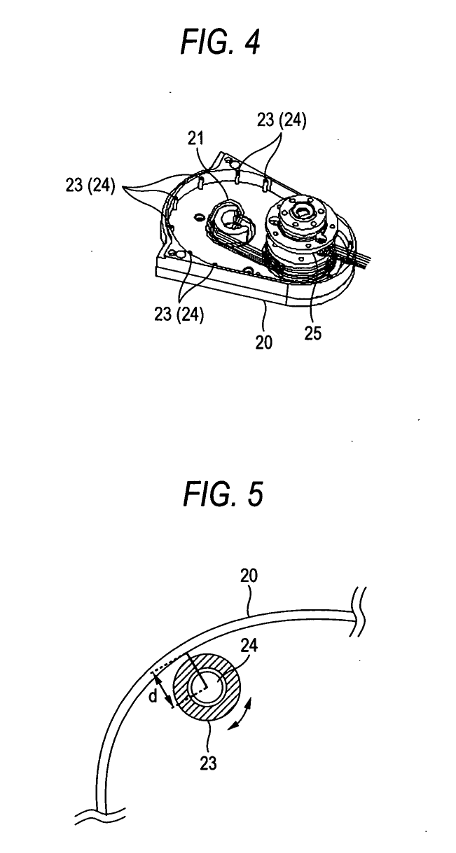

FIG. 4 is a perspective view taken in the direction of arrow A in FIG. 1. FIG. 4 is a view drawn when the casing 20 is taken out from the second arm 2. As shown in FIG. 4, a plurality of roller shafts 24 are arranged in the casing 20 along the inner wall of the casing 20. The pipe-shaped rollers 23 are arranged in such a manner that each roller shaft 24 is inserted into the hollow portion of each pipe-shaped roller 23.

FIG. 5 is an upper view of each roller 23 and roller shaft 24 arranged in the casing 20. The inner diameter of the hollow portion of the roller 23 is larger than the outer diameter of the roller shaft 24, and the outer diameter of the roller 23 is smaller than the distance (d in the drawing) from the center of the roller shaft 24 to the inner wall of the casing 20. Therefore, the roller 23 can be freely rotated in the direction of an arrow shown in FIG. 5.

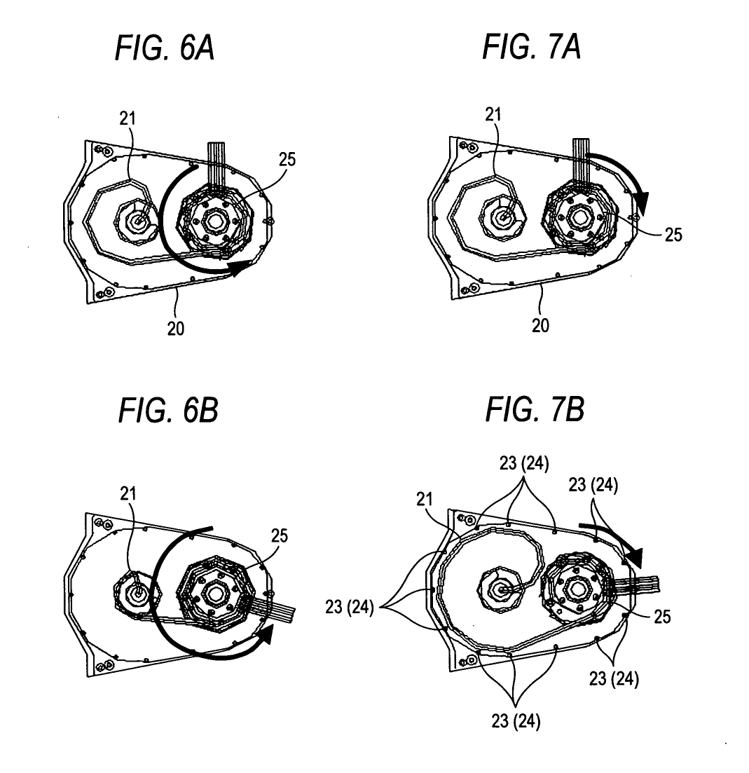

FIGS. 6 and 7 are upper views showing a state in which the cable 21 accommodated in the casing 20 is acted when the hand 6 is rotated.

For example, when the hand 6 is rotated in the direction of the reference sign + shown in FIG. 3, the fixing part 25 is rotated in the direction of an arrow shown in FIG. 6A and the cable 21 in the casing 20 is pulled to the hand 6 side, and the cable 21 is wound round the fixing part 25, to which the hand 6 is attached, as shown in FIG. 6B.

On the contrary, when the hand 6 is rotated in the direction of the reference sign − shown in FIG. 3 and the fixing part 25 is rotated in the direction of an arrow shown in FIG. 7A and the cable 21 in the casing 20 is pushed from the hand 6 side, as shown in FIG. 7B, the cable 21, which is wound round the fixing part 25, spreads in the casing 20 and comes close to the inner wall of the casing 20. However, since the rollers 23 are arranged on the inner wall, the inner wall of the casing 20 and the cable 21 are not directly contacted with each other. Due to the foregoing, the contact area can be reduced and the frictional resistance can be decreased.

Further, as described before, since the rollers 23 can be freely rotated round the rotary shaft of the hand 6, the frictional resistance caused when the cable 21 moves on the wall face of the casing 20 can be reduced. That is, even when the hand 6 is rotated, the cable 21 can be smoothly moved inside the casing 20. Therefore, no stress and tension are given to the cable 21, and the breaking of wire, which is caused by the repeated motions, can be prevented.

Although not shown in the drawing, the upper and lower faces inside the casing are subjected to the treatment of fluorine contained resin. Since the coefficient of friction of fluorine contained resin is low, the cable 21 inside the casing 20 can be more smoothly slid, which can contribute to a reduction of the sliding resistance of the joint portion and a prevention of the breaking of wire of the cable 21. In this connection, the upper and lower faces inside the casing are not necessarily subjected to the treatment of fluorine contained resin. Alternatively, a tape, which is subjected to the treatment of fluorine contained resin, may be stuck on the inner surface of the casing 20.

As can be understood from FIGS. 2 and 3, the contour of the casing 20 is the same as that of the second arm 2. Concerning the volume of the casing 20, it is sufficient to prepare an area for accommodating the cable 21 which is wound round and separated from the fixing part 25 according to the rotary motion of the hand 6 and also to prepare an area for accommodating the rollers 23. Concerning the direction of height, it is sufficient to prepare a size of the diameter of the cable 21. Further, concerning the inside of the forward end portion of the second arm 2, it is sufficient to provide a space in which the cable 21 can pass through. Therefore, an increase in the size of the robot joint portion of the cable processor of the present invention can be prevented.

In this embodiment, explanations are made into a case of the robot having two hands attached to the forward end portion of the arm and the rotary shafts of the two hands are arranged in the same axis. However, even when the number of hands is not less than 3, as long as the casing 20 is put in the direction of the rotary shaft of the hand, the present invention can be also applied. In this case, since the contour of the casing 20 is the same as that of the arm as described above, an area of the arm is not increased when a view is taken in the direction of the rotary shaft of the hand. Therefore, it is possible to reduce the space.

In this connection, explanations are made into a case of the horizontal multiple joint robot. However, the embodiment of the present invention is not limited to the above specific case. The present invention can be applied to a robot having a rotary shaft such as a vertical multiple joint robot.

The present invention can be applied to joint portions of various type robots and mechanisms in which cables extended to a forward end portion of the drive portion are accommodated.

According to the invention described in aspect 1, it is possible to downsize the joint portion of a robot. Further, when the joint is rotated, the cable can be smoothly moved. Therefore, the sliding resistance of the joint portion of the robot can be decreased. Furthermore, since no stress is given to the cable itself, the breaking of wire and the leakage of air can be prevented.

According to the invention described in aspect 2, the friction of the cable can be further decreased at the time of rotating the joint.

According to the invention described in aspect 3, even in the case of a robot having a plurality of hands at the forward end of the arm, cables can be supplied to the respective hands without increasing the size of the joint portion.

1. A cable processor of a robot for accommodating a cable inside an arm of the robot,
the cable processor comprising:
a casing portion for accommodating the cable, arranged in a joint drive portion of the robot, and
rollers arranged on an inner wall of the casing portion, rotating round a drive shaft of the joint portion.

2. The cable processor of a robot according to claim 1, wherein
an upper face and a lower face inside the casing is subjected to the treatment of fluorine contained resin.

3. The cable processor of a robot according to claim 1, wherein
the contour of the casing is the same as that of the robot arm.

4. The cable processor of a robot according to claim 1, wherein
the cable is an air pipe or an electric wire.
